(19) United States
(12) Patent Application Publication
(10) Pub. No.: US 2007/0160330 A1
(43) Pub. Date: Jul. 12, 2007

(54) Optical connector and board

(75) Inventors: Kenji Yamazaki, Ebina (JP); Toshimichi Iwamori, Ebina (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/525,083

(22) Filed: Sep. 22, 2006

(30) Foreign Application Priority Data
Jan. 11, 2006 (JP) 2006-003893

(51) Int. Cl. G02B 6/36; G02B 6/12

(52) U.S. Cl. 385/88; 385/14; 385/92

(57) ABSTRACT

An optical connector mounted on a board comprises an optical connector main body that performs optical transmission and a fixing pin that fixes the optical connector main body to the board. The optical connector main body has a pin insertion hole that the fixing pin is inserted.

### BACKGROUND

(i) Technical Field

The present invention relates to an optical connector and a board used in optical wiring in which light is a medium.

(ii) Related Art

Recently, communication system to which a high-speed and large-capacity optical transmission technology is applied is becoming widespread. An optical fiber and an optical waveguide are widely used when boards are connected to each other by optical wiring in which light is a medium. Frequently large stress is applied to an optical connector which is attached to an end portion of the optical fiber or optical waveguide due to cable routing during attaching and detaching the optical fiber in an instrument assembly process or the like. Therefore, a structure which can withstand the stress during attaching and detaching the optical fiber is required for the optical connector.

### SUMMARY

An optical connector according to an aspect of the invention is an optical connector mounted on a board comprising:

an optical connector main body that performs optical transmission; and

a fixing pin that fixes the optical connector main body to the board,

the optical connector main body defining a pin insertion hole that the fixing pin is inserted.

### BRIEF DESCRIPTION OF THE DRAWINGS

Exemplary embodiments of the present invention will be described in detail based on the following figures, wherein:

FIG. 1 shows a procedure in which an optical connector is mounted on a board according to an exemplary embodiment of the invention;

FIG. 2 shows a schematic configuration of the optical connector according to an exemplary embodiment of the invention;

FIG. 3 shows an optical connector according to another exemplary embodiment of the invention;

FIG. 4 shows an optical connector according to still another exemplary embodiment of the invention;

FIG. 5 shows a board according to an exemplary embodiment of the invention; and

FIG. 6 shows a board according to another exemplary embodiment of the invention.

### DETAILED DESCRIPTION

Exemplary embodiments of the invention will be described below with reference to the accompanying drawings.

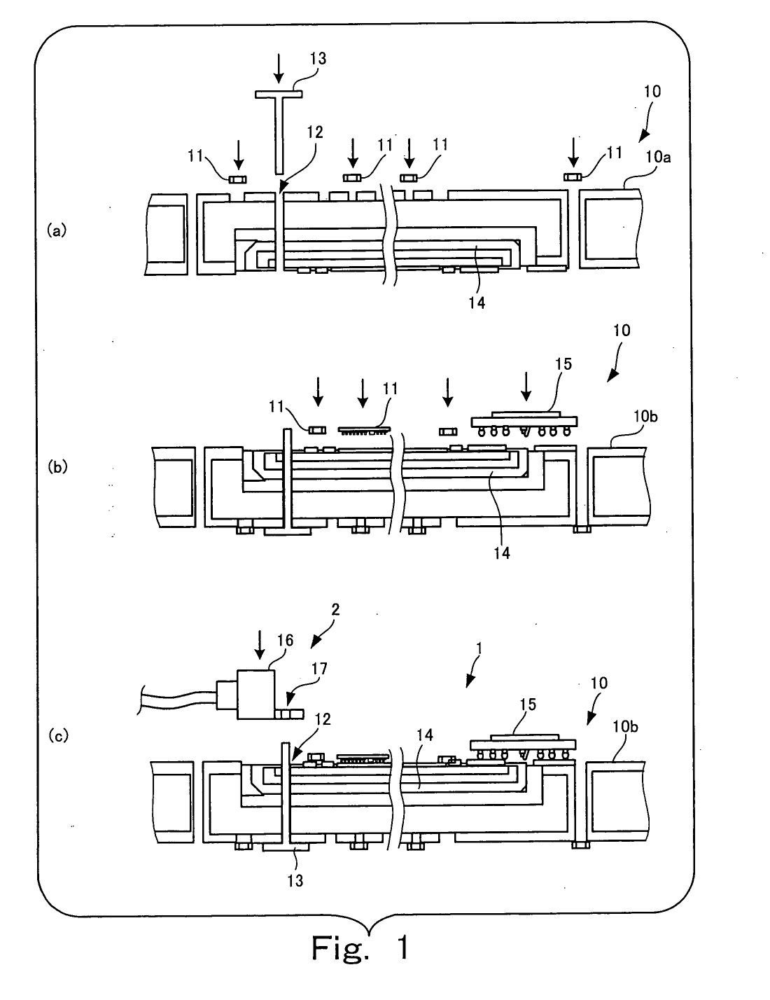

FIG. 1 shows a procedure in which an optical connector is mounted on a board according to an exemplary embodiment of the invention.

As shown in Part (a) of FIG. 1, SMD (Surface Mount Device) components 11 such as LSI are surface-mounted on one of surfaces 10a of a board main body 10, and a fixing pin 13 is inserted into a pin insertion hole 12 provided in the board main body 10 after a reflow process. An optical waveguide 14 through which the optical signal is transmitted is formed in the board main body 10. The fixing pin 13 fixes the later-mentioned optical connector main body to the board main body 10.

As shown in Part (b) of FIG. 1, other components 11 such as a light emitting and receiving device 15 are surface-mounted on the other surface 10b of the board main body 10, and the reflow process is performed. In doing so, the light emitting and receiving device 15 is mounted onto a position where optical signal transmission is performed with an optical waveguide 14. The light emitting and receiving device 15 corresponds to a signal medium conversion device of the invention.

As shown in Part (c) of FIG. 1, an optical connector main body 16 is aligned with and mounted on the surface 10b of the board main body 10. A pin insertion hole 17 into which the fixing pin 13 is inserted is formed in the optical connector main body 16, and the board main body 10 and the optical connector main body 16 are aligned with each other by inserting the fixing pin 13, inserted into the pin insertion hole 12 of the board main body 10, into the pin insertion hole 17.

Then, the optical connector main body 16 is fixed to the board main body 10 through the fixing pin 13 using a UV curable resin or the like.

Consequently, a board 1 including the board main body 10 and an optical connector 2 is obtained. On the board main body 10, the light emitting and receiving device 15 for performing the conversion between the electric signal and the optical signal is mounted at the position where optical signal transmission is performed with the optical waveguide 14. The optical connector 2 is mounted on the board main body 10, and carries the function of the optical signal transmission between the board main body 10 and the outside, where the optical signal is transmitted between the optical connector main body 16 and light emitting and receiving device 15 through the optical waveguide 14.

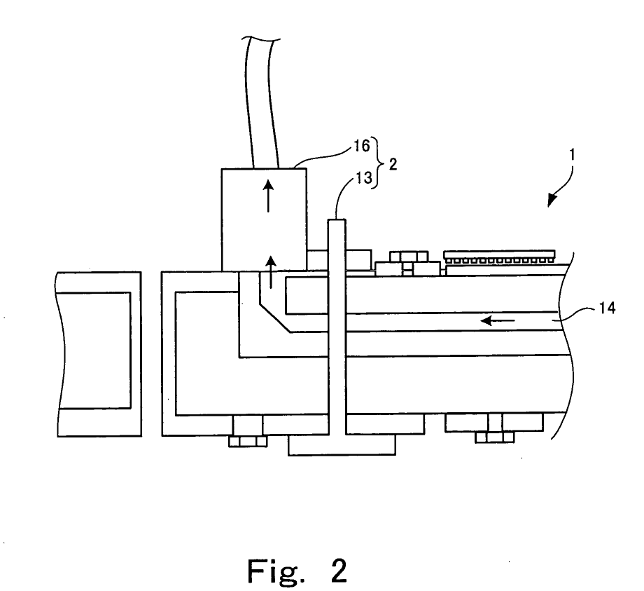

FIG. 2 shows a schematic configuration of the optical connector of the exemplary embodiment.

As shown in FIG. 2, the optical connector 2 of the exemplary embodiment is mounted on the board 1 in which the optical waveguide 14 through which the optical signal is transmitted, and the optical signal is transmitted between the board land the outside through the optical connector 2. The optical connector 2 includes the optical connector main body 16 and the fixing pin 13. The optical connector main body 16 carries the function of the optical signal transmission, and the fixing pin 13 fixes the optical connector main body 16 to the board 1 when the optical connector main body 16 is mounted on board 1. The pin insertion hole 17 into which the fixing pin 13 is inserted is formed in the optical connector main body 16.

Then, an optical connector according to another exemplary embodiment of the invention will be described.

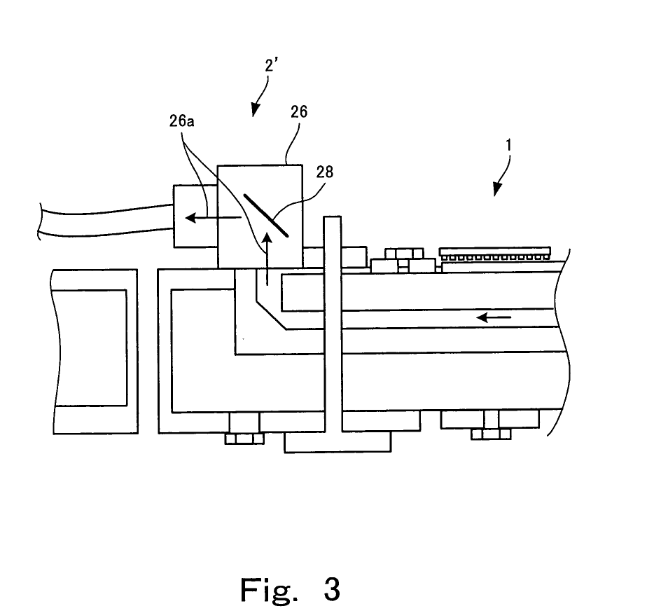

FIG. 3 shows an optical connector according to another exemplary embodiment of the invention.

As shown in FIG. 3, a connector 2′ includes an optical path changing unit 28 which changes an optical path 26a of an optical connector main body 26 to any direction, and the function of the optical connector can be enhanced by including the optical path changing unit 28. For example, for the board 1 having the structure integrated with the connector 2′, a degree of freedom for the arrangement can largely be improved in the electronic instruments. A mirror and a prism can be used as the optical path changing unit 28.

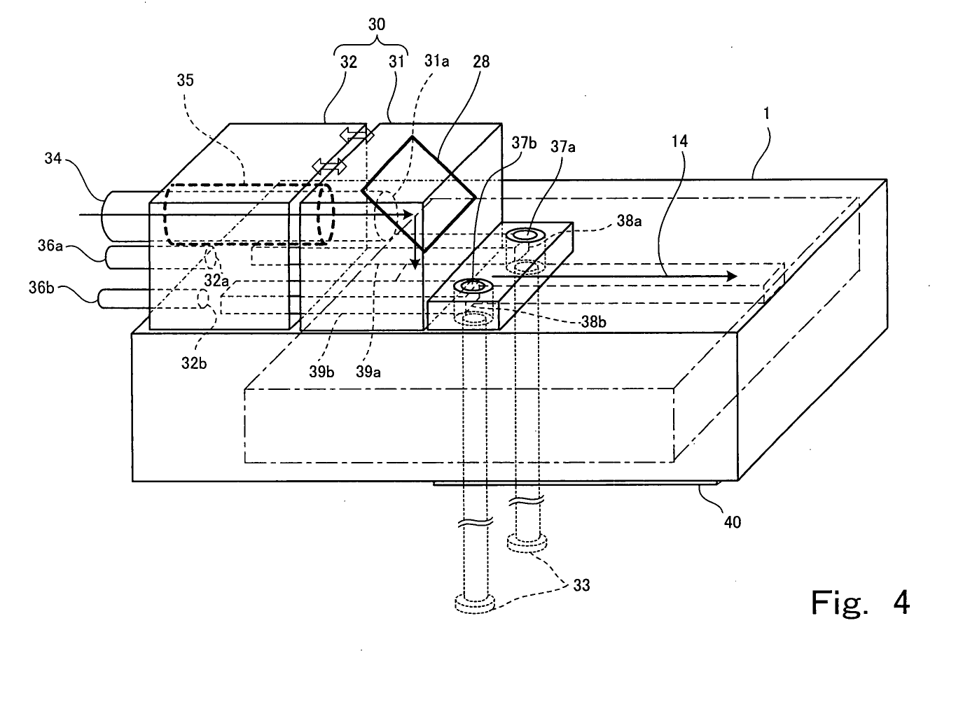

FIG. 4 shows an optical connector according to still another exemplary embodiment of the invention.

As shown in FIG. 4, in the exemplary embodiment, the board 1 is a co-called photo-electric integrated board on which the electronic components are mounted along with the optical waveguide 14, and an optical connector main body 30 includes an optical connector unit 31 and an electric connector unit 32. The optical connector unit 31 carries the function of the optical signal transmission between the board 1 and the outside, and the electric connector unit 32 carries the function of the electric signal transmission between the board 1 and the outside. A fixing pin 33 fixes the optical connector main body 30 to the board 1 when the optical connector main body 30 is mounted on the board 1. The fixing pin 33 also carries the function of the electric signal transmission between the optical connector main body 30 and the electronic components mounted in an electric wiring layer 40 on the board 1.

The optical connector unit 31 and the electric connector unit 32 are configured to be detachable by a plug-in type connector. After the optical connector unit 31 is fixed to the board 1 by inserting the fixing pins 33, inserted into the board 1, into insertion holes 37a and 37b formed in the optical connector unit 31, the electric connector unit 32 is inserted into the optical connector unit 31 to form the hybrid type optical connector of the exemplary embodiment.

An optical fiber 34 is connected to an end portion 31a of the optical connector unit 31, and the optical fiber 34 is extended to the outside through a through hole 35 which is formed in the electric connector unit 32.

Light incident to the optical connector unit 31 through the optical fiber 34 passes through the end portion 31a of the optical connector unit 31, and the light is guided to the optical waveguide 14 after an optical path direction is changed by an optical path changing unit (mirror) 28 formed in the optical connector unit 31.

Electric cables 36a and 36b are connected to end portions 32a and 32b of the electric connector unit 32, and the electric cables 36a and 36b are extended to the outside. The end portions 32a and 32b of the electric connector unit 32 are connected to electric connection points 38a and 38b through electric connection electrodes 39a and 39b. The electric connection electrodes 39a and 39b are formed in the board 1, and the electric connection points 38a and 38b are provided inside openings of the insertion holes 37a and 37b into which the fixing pins 33 are inserted. Because the electric connection points 38a and 38b are connected to electronic components mounted in an electric wiring layer 40 on the board 1, the electronic components are electrically connected to the outside through the electric cables 36a and 36b.

In the exemplary embodiment, the electric connector unit 32, the electric connection electrodes 39a and 39b, and the electric connection point 38a, 38b correspond to the electric connection unit in the invention.

As described above, the optical connector of the embodiment is a connector of the hybrid type, which enables the optical waveguide and electric circuit on the board 1 to be optically and electrically connected to the external device.

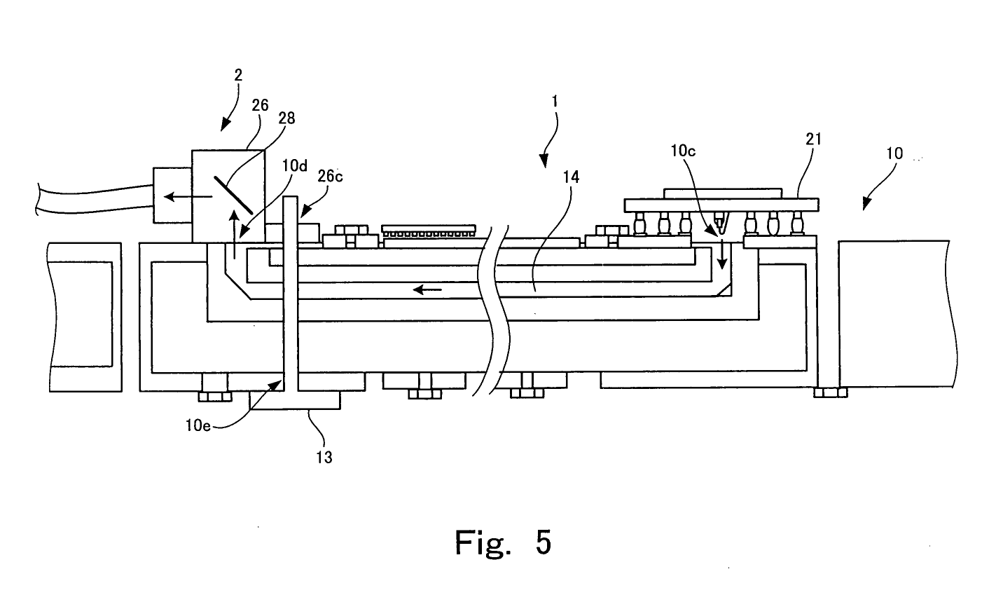

FIG. 5 shows a board according to an exemplary embodiment of the invention.

The board 1 includes the board main body 10 and the optical connector 2. The optical waveguide 14 through which the optical signal is transmitted is formed in the board main body 10. In the board main body 10, a light emitting device module 21 which carries the function of the conversion between the electric signal and the optical signal is mounted at a position 10c where the optical signal transmission is performed with the optical waveguide 14. The optical connector 2 includes the optical connector main body 26 and the fixing pin 13. The optical connector main body 26 carries the function of the optical signal transmission. The fixing pin 13 fixes the optical connector main body 26 to the position 10d where the optical signal transmission is performed between the optical connector main body 26 and the optical waveguide 14. The board main body 10 and the optical connector main body 26 have pin insertion holes 10e and 26c into which the fixing pins 13 are inserted respectively.

Similarly to the connector 2′ shown in FIG. 3, the optical connector main body 26 of the exemplary embodiment includes the optical path changing unit 28, so that the optical path in the optical connector main body 26 can be changing to any direction by the optical path changing unit 28.

The light emitting device module 21 corresponds to the signal medium conversion device in the invention.

According to the board 1 of the exemplary embodiment, the general-purpose plastic material having excellent formability can be employed, because the heat resistant property is not required for the material employed in the optical connector main body 26. Therefore, the highly-functional and low-cost board on which the light emitting device module is mounted can be obtained.

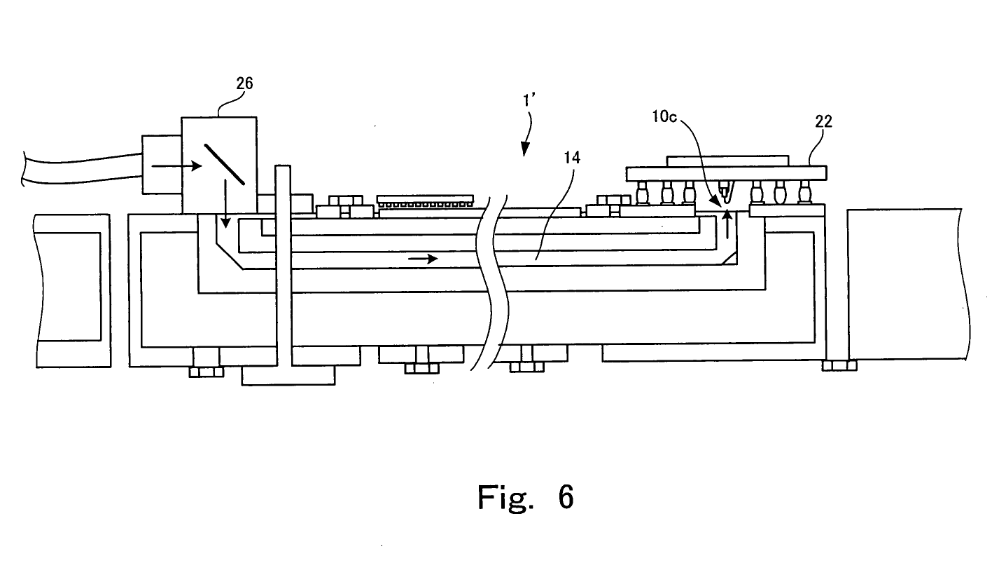

FIG. 6 shows a board according to another exemplary embodiment of the invention.

The board 1′ has the configuration similar to the board 1 shown in FIG. 5. However, board 1′ differs from the board 1 in that, instead of the light emitting device module 21 shown in FIG. 5, a light receiving device module 22 which carries the function of the conversion between the electric signal and the optical signal is mounted at the position 10c where the optical signal transmission is performed with the optical waveguide 14.

The light receiving device module 22 corresponds to the signal medium conversion device in the invention.

According to the board 1′ of the exemplary embodiment, similarly to the board 1 shown in FIG. 1, the general-purpose plastic material having excellent formability can be employed, because the heat resistant property is not required for the material employed in the optical connector main body 26.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling other skilled in the art to understand the invention for various embodiments and with the various modifications as are suited to the particular use contemplated. It is intended that the scope of the invention be defined by the following claims and their equivalents.

What is claimed is:

1. An optical connector mounted on a board comprising:
an optical connector main body that performs optical transmission; and
a fixing pin that fixes the optical connector main body to the board,
the optical connector main body defining a pin insertion hole that the fixing pin is inserted.

2. The optical connector according to claim 1, wherein an optical waveguide that transmits an optical signal is mounted on the board, and the optical connector carrying a function of optical signal transmission between the board and an outside, and the fixing pin fixes the optical connector main body when the optical connector main body is mounted on the board.

3. The optical connector according to claim 1, wherein the optical connector main body includes an optical path changing unit that changes a direction of an optical path in the optical connector main body.

4. The optical connector according to claim 1, wherein an electronic component is mounted on the board, the optical connector main body includes an electric connection unit that carries the function of electric signal transmission between the board and the outside, and
the fixing pin also carries the function of the electric signal transmission between the optical connector main body and the electronic component on the board.

5. A board comprising:
an optical waveguide transmitting an optical signal and being mounted on the board;
a board main body including a signal medium conversion device, the signal medium conversion device carrying a function of conversion between an electric signal and an optical signal, and the signal medium conversion device being mounted at a position where optical signal transmission is performed through the optical waveguide; and
an optical connector being mounted on the board main body and carrying a function of the optical signal transmission between the board main body and an outside,
the optical connector including:
an optical connector main body that carries a function of optical transmission; and
a fixing pin that fixes the optical connector main body to a position where an optical signal is transmitted between the optical connector main body and the optical waveguide,
the board main body and the optical connector main body defining pin insertion holes that the fixing pins are inserted respectively.
